(19) United States
(12) Patent Application Publication
(10) Pub. No.: US 2004/0173114 A1
(43) Pub. Date: Sep. 9, 2004

(54) Plate material for printing and method for regenerating/reusing plate material for printing and printing machine

(76) Inventors: Yasuharu Suda, Hiroshima-ken (JP); Toyoshi Ohto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/476,873

(22) PCT Filed: Jan. 30, 2003
(86) PCT No.: PCT/JP03/00893

(30) Foreign Application Priority Data
Feb. 12, 2002 (JP) 2002-034503

(51) Int. Cl. B41N 3/00

(52) U.S. Cl. 101/467

(57) ABSTRACT

A printing plate has a surface layer (3) which includes a photocatalyst that responds to visible light as well as ultraviolet light and on which a coating (4) made of an organic compound having a hydrophobic group is formed so that it is possible to form an image on the surface of the printing plate by irradiating with visible light and to regenerate the printing plate by deleting the formed image whereupon the printing plate can be reused.

### TECHNICAL FIELD

The present invention relates to a reusable printing plate on which an image is formed by irradiating a surface of the printing plate with light and which is regenerated by deleting the image formed on the surface, to a method for regenerating and reusing the printing plate, and to a printing press on which the above printing plate is mounted and which allows the printing plate to be made ready for printing and be regenerated being mounted on the printing press.

### BACKGROUND OF THE INVENTION

In recent years, digitalization of printing processes has been progressing in the art. This technology involves creation of images and manuscripts in digitized form on a personal computer or reading images with a scanner and directly makes a printing plate based on the digital data thus obtained. This makes it possible to save labor in the whole printing processes and also to conduct high-definition printing with ease.

So-called PS plates (presensitized plates) have been commonly used as printing plates to date. A PS plate includes a hydrophilic non-image area made of anodized aluminum and one or more hydrophobic image areas formed by curing a photosensitive resin on the surface of the anodized aluminum. Making a printing plate ready for printing with such a PS plate requires a number of steps and hence, is time-consuming and costly. It is therefore difficult to reduce the time and the cost required for a printing process. Especially in short-run printing, the requirement for such plural steps causes increased printing costs. Additionally, since use of a PS plate requires a development step using a developer, serious problems arise not only with the need for considerable amounts of labor but also with environmental pollution caused by treatment of developer waste in view of the prevention of environmental pollution.

Further, it is a common practice to expose a PS plate the surface of which is in contact with a film through which a desired image is perforated to light. This causes problems in making the printing plate ready for printing directly from digital data and in promoting a digitized printing process. Moreover, after completion of printing of a pattern, it has been necessary to replace the printing plate with another one in order to conduct printing of the next pattern, and used printing plates have been thrown away.

To solve the above-described problems of PS plates, methods have been proposed to meet the digitization of a printing process while making it possible to omit the development step, and some of such methods have come into commercial use. For example, Japanese Patent Application Laid-Open (KOKAI) Publication No. SHO 63-102936 discloses a process of making a plate ready for printing comprising the steps of: applying ink containing a photosensitive resin used as an ink for a liquid ink-jet printer to the surface of a printing plate; and curing an image area by irradiation with light. Japanese Patent Application Laid-Open (KOKAI) Publication No. HEI 11-254633, on the other hand, discloses a process for making a color offset printing plate ready for printing by an ink-jet head through which solid ink is jetted.

Also included in known methods are a process for making a printing plate ready for printing, which comprises the step of writing, with a laser beam, an image on a printing plate, which is made of a PET (polyethylene terephthalate) film on which a laser absorbing layer such as carbon black covered with a silicone resin layer is formed, to cause the laser absorbing layer to evolve heat, which ablates off the silicone resin layer; and another process for preparing a printing plate ready for printing comprising the step of coating a lipophilic laser absorbing layer on an aluminum plate, coating a hydrophilic layer on the laser absorbing layer, and then ablating off the hydrophilic layer with a laser beam as in the above-described process.

Another proposed method discloses a printing plate made of a hydrophilic polymer, which plate is made ready for printing by lipophilizing an irradiated portion subjected to image exposure. Further, a method in which an image is written on a PS plate with a laser beam directly from digital data is disclosed and a so-called CTP (Computer to Plate) that is an imaging device utilizes a violet laser beam having a wavelength of 405 nm, or a combination a micromirror and a UV lamp is available on the market.

Although these method can make a printing plate ready for printing directly from digital data, replacement of a printing plate after printing one pattern with a new printing plate is required for the next printing. Therefore, these methods do not improve on the point that a printing plate used for one printing process is discarded.

For example, Japanese Patent Application Laid-Open (KOKAI) Publication No. HEI 10-250027 refers to a latent image block copy making use of a titanium dioxide photocatalyst, a fabrication process of the latent image block, and a printing press having the latent image block. Japanese Patent Application Laid-Open (KOKAI) Publication No. HEI 11-147360 also discloses an offset printing process of a printing plate making use of a photocatalyst. Each of these disclosures forms an image using light, i.e., ultraviolet light, practically, to activate the photocatalyst and regenerates the printing plate by hydrophobization of the photocatalyst caused by heat treatment.

Further, Japanese Patent Application Laid-Open (KOKAI) Publication No. HEI 11-105234 discloses a method for making a printing plate ready for printing comprising the step of hydrophilizing a photocatalyst with activating light, i.e., ultraviolet light, and then forming an image area by a heat-mode recording.

As disclosed in the paper (pages 124-125) entitled “Study of Photo-Induced Hydrophilic Conversion on the TiO₂ Surface Involved by Structural Conformation”, (by Minabe et al.) distributed at the Fifth Symposium on “Recent Developments of Photocatalytic Reactions” of the Photo Functionalized Materials Society in 1998, Prof. Fujishima, Prof. Hashimoto, et al. of the Research Center for Advanced Science and Technology, The University of Tokyo, have confirmed that a titanium dioxide photocatalyst is hydrophilized by heat treatment. According to the description in the above paper, the processes disclosed in the above laid-open patent applications referred to in the above, a printing plate cannot be regenerated for reusing or cannot be made a printing plate ready for printing.

Considering the above circumstances, the Inventors have developed a printing plate, on which an image can be written directly from digital data without a wet development step and which can be reused by regeneration, and a regeneration method for the printing plate, and have applied a patent application for the printing plate (Japanese Patent Application number HEI 10-229110).

Successively, the Inventors have been enthusiastically researching to develop a printing plate able to be made ready for printing and be regenerated by a device more tractable for handling and more compact in size.

In other words, the present invention aims at providing a reusable printing plate able to be made ready for printing directly from digital data by a tractable compact device and be regenerated, and a regenerating and reusing method for the printing plate.

Further, the present also aims at providing a printing press incorporates a regeneratable printing plate by utilizing the above reusable printing plate, which printing press is tractable for handling and compact in size.

### DISCLOSURE OF THE INVENTION

To attain the above aim, there is provided a reusable printing plate on which an image is formed by irradiating a surface of the printing plate with light and which is regenerated by deleting the formed image, wherein a coating made of an organic compound having a hydrophobic group is formed on the surface of a photosensitive layer including a photocatalyst that responds to visible light. Since a photocatalyst is activated when being irradiated with light having energy higher than the band-gap energy of the photocatalyst, conventional technique concretely utilizes ultraviolet light as an example. It is sure that ultraviolet light can easily activate a photocatalyst causing the photocatalyst to exhibit photocatalytic activity because of its high energy due to a short wavelength of ultraviolet light. On the other side, ultraviolet light requires to be treated with care and an irradiating unit used for forming an image is large in size. As a solution, in the present invention, the usage of the photocatalyst that responds also to visible light can utilize an irradiating unit for visible light as an image forming unit and a tractable and compact irradiating unit is realized.

Needless to say, a photocatalyst that responds to visible light responds also to ultraviolet light having higher energy than visible light. As a preferable feature, the photocatalyst responds to light having a wavelength equal to or shorter than 600 nm, at least equal to or shorter than 500 nm. In the following description, activating light represents light having energy effective on causing a photocatalyst to exhibit photocatalytic activity.

The photocatalyst has a property that is converted by irradiation with activating light and a property that oxidatively decomposes an organic compound on the surface. As a preferable feature of the present invention, the image is formed by exposure the hydrophilic surface of the photosensitive layer which exposure is caused by oxidatively decomposing the organic compound by the photocatalyst. Since the property of the photocatlyst is converted to hydrophilic by irradiating with the activating light, the initial state of the photosensitive layer may be hydrophilic or hydrophobic. The exposed portion of the hydrophilic photosensitive layer serves as a non-image area to which a fountain solution preferentially adheres but hydrophobic ink does not adhere. On the other hand, the portion of the plate surface that has not been irradiated with the activating light serves as an image area to which the hydrophobic ink preferentially adheres but the fountain solution does not adhere because the organic compound keeps covering the portion.

The printing plate can be regenerated by covering the hydrophilic surface of the photosensitive layer with the organic compound which covering is caused by an interaction of the organic compound with the photosensitive layer. The interaction may accompany a chemical reaction. The interaction of the organic compound with the photosensitive layer is performed by applying vapor of the organic compound to the surface of the printing plate or applying a liquid of the organic compound or a liquid including the organic compound to the surface of the printing plate.

A titanium oxide photocatalys or a modified titanium oxide photocatalyst can be used as the photocatalyst. Here, a modified titanium oxide photocatlayst is formed by doping or containing a metal or non-metal element other than elements originally included in the titanium oxide photocatalyst based on the titanium oxide photocatalyst or by changing the stoichimetric ratio of a titanium dioxide photocatalyst in which the ratio of Ti atoms and O atoms are included in a ratio of 1:2. The modified titanium oxide photocatlayst is obtained by improving a titanium oxide photocatalyst so as to respond to visible light as well as ultraviolet light because of setting a new level in the band gap of the titanium oxide photocatalyst.

The present invention also provides a method for regenerating and reusing a printing plate comprising the steps of: upon completion of printing, removing ink from the surface of the printing plate (ink removing step); hydrophobizing the entire surface of the printing plate by covering an exposed portion of the photosensitive layer with the organic compound (hydrophobizing step); and forming the image by irradiating a portion of the printing plate with visible light so that the organic compound at the irradiated portion is decomposed by an action of the photocatalyst and the hydrpophilic surface of the photosensitive layer at the irradiated portion is exposed (image forming step). This regenerating and reusing method regenerates and repetitiously uses a printing plate whereupon it is possible to reduce an amount of printing plates discarded after being used for printing, reducing costs for printing plates. Further, since it is possible to reduce time required for regenerating of the printing plate, especially to form an image, during a printing process, time required to prepare for printing can be advantageously reduced.

The step of hydrophobizing is performed by applying vapor of the organic compound to the surface of the printing plate or by applying a liquid of the organic compound or a liquid including the organic compound to the surface of the printing plate to interact the organic compound with the photosensitive layer so that the hydrophilic surface of the photosensitive layer is covered with the organic compound.

The method preferably comprises the step of, before covering the exposed portion of the photosensitive layer with the organic compound in the step of hydorphobizing, irradiating the entire surface of the printing plate with activating light, i.e., light having a wavelength equal to or shorter than that of visible light. Irradiation with light having a wavelength equal to or shorter than that of visible light causes the action of the photocatlyst to decompose all of the remaining organic compound. This makes the entire surface of the printing plate hydrophilic and an image area is thereby deleted whereupon it is possible to further evenly regenerate the entire surface of the printing plate. The activating light irradiated can be not only visible light having a wavelength in the range of 400-600 nm but also ultraviolet light having a wavelength of equal to or shorter than 400 nm or light between ultraviolet light and visible light.

The step of ink removing is performed, for example, by moving the ink to paper while a printing press is operating without supplying the printing plate with ink; by wiping off the ink with a reeled cleaning cloth tape; by wiping off the ink with a roller around which cloth is wrapped; or by spraying a solvent having an effect on washing off ink onto the surface of the printing plate to wash off the ink.

Still further, the present invention provides a printing press on which a printing plate is made ready for printing. The printing press comprises: a plate cylinder having a curved surface for supporting a printing plate; an image forming unit for writing a non-image area by irradiating a portion of the surface of the printing plate with visible light so that the organic compound at the irradiated portion is decomposed by an action of the photocatalyst and the hydrophilic surface of the photosensitive layer at the irradiated portion is exposed; and a hydrophobization unit for hydrophobizing the entire surface of the printing plate by covering the exposed portion of the photosensitive layer with the organic compound. With this arrangement in the printing press on which a printing plate is made ready for printing, making a printing plate ready for printing and regenerating of a printing plate can be carried out keeping the printing plate being mounted on the plate cylinder so that it is possible to continue printing processes without interruption due to plate replacement.

The printing plate may be a separated form from a plate cylinder, around which the printing plate is wrapped, or the curved surface of the plate cylinder may function as a printing plate.

As a preferable feature, the printing press further comprises a plate cleaning unit for removing ink from the surface of the printing plate and an image area deleting unit for deleting an image area by irradiating the entire surface of the printing plate with activating light, i.e., light having a wavelength equal to or shorter than that of visible light. The image area deleting unit takes the form of a light source for irradiating ultraviolet light having a wavelength of equal to or shorter than 400 nm, or light between ultraviolet light and visible light as well as visible light having a wavelength in the range of 400-600 nm.

### BRIEF DESCRIPTION OF THE DRAWINGS

FIG. 1 is a sectional view showing the surface of a printing plate according to a first embodiment of the present invention and concurrently showing a photosensitive layer thereof in a hydrophobic state;

FIG. 2 is a sectional view showing the surface of the printing plate according to the first embodiment of the present invention and concurrently showing a photosensitive layer thereof in a hydrophilic state;

FIG. 3 is a schematic diagram illustrating procedural steps of making the printing plate of the first embodiment ready for printing and regenerating the printing plate according to the first embodiment;

FIG. 4 is a perspective view illustrating an example of an image (an image area) and a white background (a non-image area) formed on the printing plate;

FIG. 5 is a graph showing a change in contact angle (i.e., a hydrophobic/hydrophilic state) of the printing plate of the first embodiment in accordance with time passage and steps performed; and

FIG. 6 is a diagram illustrating an example of a printing press on which the printing plate of the first embodiment is mounted.

### BEST MODE FOR CARRYING OUT THE INVENTION

A first embodiment of the present invention will now be described with reference to the accompanying drawings.

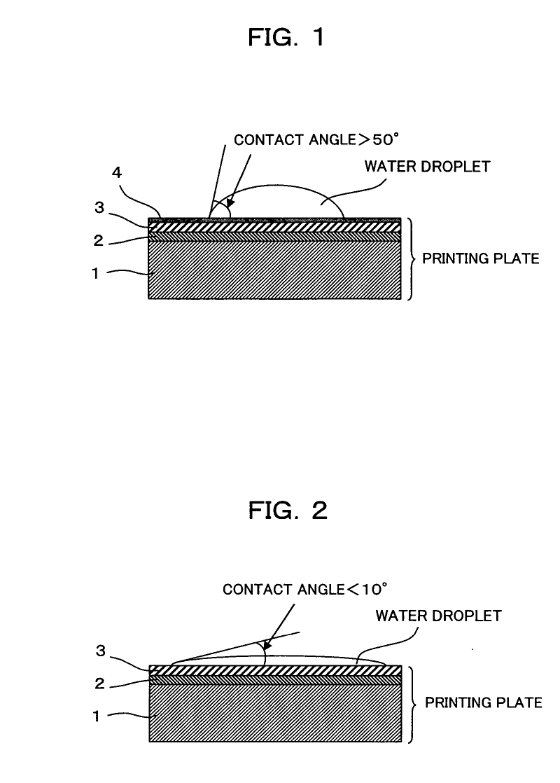

FIG. 1 shows a sectional view of the surface of a printing plate according to the first embodiment of the present invention. The printing plate basically includes a substrate 1, an intermediate layer 2, a photosensitive layer (a plate surface layer) 3 and a hydrophobic coating 4. In this drawing, the substrate 1 is made of metal, such as aluminum or stainless steel, or a polymer film. However, the material of the substrate 1 of the present invention should by no means be limited to metal of aluminum or stainless steel, or a polymer film.

The intermediate layer 2 is formed on the surface of the substrate 1. The intermediate layer 2 is made, for example, of silica (SiO₂) or silicon compound such as a silicon resin or a silicon rubber. In particular, silicone alkyd, silicone urethane, silicone epoxy, silicone acryl, silicone polyester or the like is used as a silicone resin. The intermediate layer 2 is formed on the substrate 1 to ensure adhesion of the substrate 1 to a later-described photosensitive layer 3 and to improve their firm adhesion. It is possible to ensure adequate adhesive strength of the photosensitive layer 1 by interposing an intermediate layer 2 as required. If sufficient adhesive strength is ensured between substrate 1 and photosensitive layer 3, the intermediate layer 2 may be omitted.

Further, the intermediate layer 2 is sometimes formed in order to enhance an activity of the photosensitive layer 3 including a photocatalyst. The intermediate layer 2 interposed between the substrate 1 and the photosensitive layer 3 as needed enhances the crystallinity of the photosensitive layer 3 and inhibits an electron and a positive hole, which are generated in the photosensitive layer 3 by irradiation with activating light, from recombination so that the activity of the photocatalyst is enhanced. However, an ensured adequate photocatalytic activity of the photosensitive layer 3 can omit the intermediate layer 2 serving an activity enhancer.

If the substrate 1 is made of a polymer film, the intermediate layer 2 may be formed in order to protect the substrate 1 as required. Additionally, if the later-described photosensitive layer 3 is formed by heat treatment, the intermediate layer 2 is also effective for preventing impurities included in the substrate 1 from thermodiffusing and from thereby mixing into photosensitive layer 3, so that a reduction in photocatalytic activity is avoided.

The photosensitive layer 3 including a photocatalyst is formed on the intermediate layer 2 (or the substrate 1). The surface of the photosensitive layer 3 comes to exhibit high hydrophilicity responsive to irradiation with activating light having energy higher than the band-gap energy of the photocatalyst. A photocatalyst originally does not show photocatalytic activity unless the photocatalyst is irradiated with light having energy higher than its band-gap energy; since a normal titanium oxide photocatalyst hasband-gap energy as high as 3 eV, the photocatalyst is responsive only to ultraviolet light. However, the present invention utilizes a photocatalyst having an energy level newly set in the band gap, which potocatalyst is thereby responsive also to light having a wavelength longer than that of ultraviolet light, so that visible light having a wavelength in the range between 400 nm through 600 nm can be used as the activating light as well as ultraviolet light.

Executing of a method already known produces a photocatalyst responsive even to visible light. For example, Japanese Patent Laid-Open (KOKAI) Publication No. 2001-207082 discloses a visible-light-responsive photocatalyst obtained by doping nitrogen atoms on the basis of a titanium oxide photocatalyst; Japanese Patent Laid-Open (KOKAI) Publication No. 2001-205104, a visible-light-responsive photocatalyst obtained by doping chromium and nitrogen atoms; and further Japanese Patent Laid-Open (KOKAI) Publication No. HEI 11-197512, a visible-light-responsive photocatalyst obtained by ion implantation using metal ions, such as chromium ions. A visible-light-responsive photocatalyst is produced by another disclosed method utilizing cryogenic plasma. A visible-light-responsive photocatalyst containing platinum is also disclosed. Fabrication of a printing plate according to the present invention can use a visible-light-responsive photocatalyst which has been produced in any of these known method.

In order to maintain the above hydrophilic property and to improve the strength of the photosensitive layer 3 and the adhesion of the photosensitive layer 3 to the substrate 1, the photosensitive layer 3 may further include the following substance, such as a silica compound exemplified by silica, silica sol, organosilane, or a silicone resin, a metal oxide or a metal hydride including, for example, zirconium, aluminum, titanium and/or a fluorocarbon resin.

The crystal structure of a base titanium dioxide photocatalyst is available in rutile, anatase and brucite. These structures are all usable in this embodiment, and they may be used in combination. In consideration of photocatalytic activity, the anatase structure is preferred because of the highest photocatalytic activity resulting from its crystal structure. As described below, a titanium oxide photocatalyst is preferably small in particle diameter in order to make photocatalytic activity high. Specifically, the particle diameter of a titanium dioxide photocatalyst is 0.1 μm or smaller, more preferably up to 0.05 μm. A preferable photocatalyst is a modified product based on a titanium oxide photocatalyst, but should by no means be limited to this.

The thickness of the photosensitive layer 3 is preferably in the range of 0.005 to 1 μm because an unduly small thickness makes it difficult to fully utilize the above-described property while an excessively large thickness makes the photosensitive layer 3 susceptible to cracks and causes a reduction in print durability. As this cracking is pronouncedly observed when the thickness exceeds 10 μm, it is necessary to consider this 10 μm as the upper limit even if one tries to enlarge this range of thickness. In practice, this thickness may preferably be set in the range of 0.03 to 0.5 μm or so.

The photosensitive layer 3 is formed by a selected one of the sol coating processes, the organic titanate process, the sputtering process, the CVD method, the PVD method and other processes. If the sol coating process is adopted, for example, a sol coating formulation employed for use in the sol coating process may contain a solvent, a crosslinking agent, a surfactant and/or the like in addition to the titanium oxide photocatalyst and the above-described substances for improving the strength of the photosensitive layer 3 and its adhesion to the substrate 1. The coating formulation may be either a room temperature drying type or a heat drying type, with the latter being more preferred because, in order to provide the resultant printing plate with improved print durability, it is advantageous to promote the strength of the photosensitive layer 3 by heating. It is also possible to form the photosensitive layer 3 of high strength, for example, by growing an amorphous titanium dioxide layer on a metal substrate by sputtering in a vacuum and then crystallizing the amorphous titanium dioxide by heat treatment or by another method.

The surface of the photosensitive layer 3 is covered with a hydrophobic coating 4. The hydrophobic coating 4 is made of an organic compound having a hydrophobic group. A preferable organic compound forming the hydrophobic coating 4 reacts or vigorously interacts with at least hydrophilic portion of the printing plate surface and covers the hydrophilic surface to hydrophobize the surface of the photosensitive layer 3 and concurrently is decomposed with ease by oxidative decomposition function of the photocatalyst when being irradiated with activating light. A preferable example is an organic titanium compound, an organic silane compound, an isocyanate compound, or an epoxide compound. These organic compounds respectively react with a hydroxy group present at the surface of a photocatalyst to be fixed to the surface, so that an organic compound monomolecular layer is formed on the surface of the photocatalyst in principle. Hydrophobizing the surface of a phtocatalyst by such a monomolecular layer decomposes the organic compound under irradiation with the activating light with ease.

The organic titanium compound is exemplified by (1) an alkoxy titanium, such as a tetra-i-propoxy titanium, a tetra-n-propoxy titanium, a tetra-n-butoxy titanium, a tetra-i-butoxy titanium or a tetrastearoxy titanium, (2) a titanium acylate, such as a tri-n-butoxy titanium stearate or an isopropoxy titanium tristearate, or (3) a titanium chelate, such as a diisopropoxy titanium bisacetylacetonate, a dihydroxy bislactato titanium or a titanium-i-propoxyoctylene glycol, but should by no means be limited to these examples.

The organic silane compound is (1) an alokoxysilane exemplified by a trimethylmethoxysilane, a trimethylethoxysilane, a dimethyldiethoxysilane, a methyltrimethoxysilane, a tetramethoxysilane, a methyltriethoxysilane, a tetraethoxysilane, a methyldimethoxysilane, an octadecyltrimethoxysilane or an octadecyltriethoxy silane, (2) a chlorosilane, such as a trimethylchlorosilane, a dimethyldichlorosilane, a metyltrichlorosilane, a methyldichlorosilane or a dimethylchlorosilane, (3) a silane coupler, such as a vinyl-trichlorosilane, a vinyl-triethoxysilane, a γ-chloropropyltrimethoxysilane, a γ-chloropropyl methyldichlorosilane, a γ-chloropropyl methyldimethoxysilane, a γ-chloropropyl methyldiethoxysilane or γ-aminopropylethoxysilane, or (4) a pholoroalkylsilane exemplified by a perpholoroalkyltrimethoxysilane, but should by no means be limited to these examples.

The isocyanate compound is an isocyanic dodecyl, or an isocyanic octadecyle, but should by no means be limited to the foregoing examples.

The epoxide compound is exemplified by a 1,2-epoxydecane, a 1,2-epoxyhexadecane, or a 1,2-epoxyoctadecane, but should by no means be limited to these examples.

If the organic compound is liquid at room temperature, the compound may be applied to the photosensitive layer 3 by a method of roll coating, blade coating or dip coating, or may be formed into microdrops by a spray and the applied to the layer. Further, photosensitive layer 3 may be coated with the organic compound in the form of gas obtained by heating the compound to a temperature below the decomposition temperature or in the form of vapor formed by a nebulizer utilizing ultrasound. Needless to say, the compound may be resolved in another solution in order to adjust its concentration and viscosity.

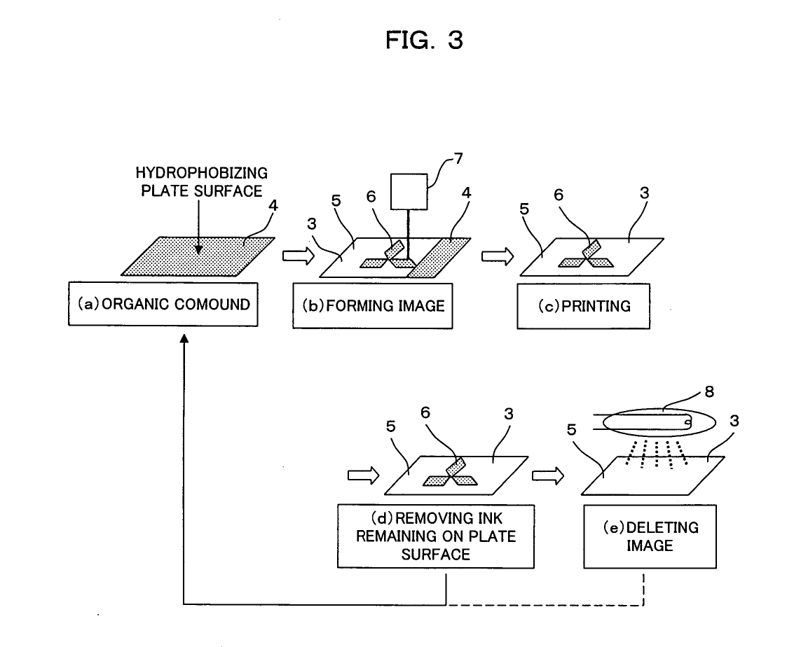

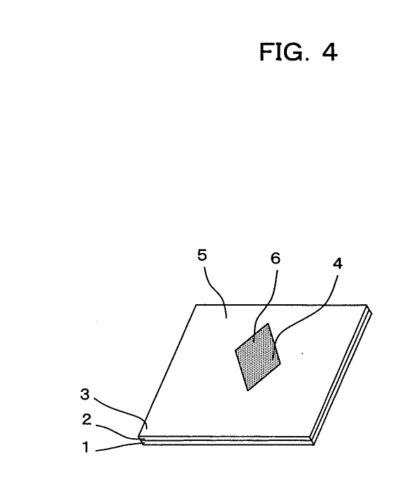

Hereinafter is a description of a method for making the printing plate ready for printing and a method for regenerating the printing plate. FIG. 3 is a schematic diagram showing individual steps, in order of steps (a) to (e), from making a printing plate ready for printing to regenerating the printing plate. “Making the printing plate ready for printing” means writing of a hydrophilic non-image area by irradiating at least part of the surface of the printing plate, the entire surface of which has been hydrophobized, with activating light in accordance with digital data so that, together with one or more hydrophobic portions on the surface of the printing plate, which portions have not been irradiated with the activating light, a latent image including a hydrophobic image area and a hydrophilic non-image area is formed on the surface of the printing plate.

First of all, the surface of the printing plate is irradiated with activating light so that an organic compound remaining on the surface of the photosensitive layer 3 is decomposed and that the entire surface comes into a hydrophilic state, as shown in FIG. 2, having a contact angle of water thereon up to 10°. As a result, the entire surface of the photosensitive layer 3 is hydrophilized and an image area formed on the surface is deleted. Although visible light can be used as the activating light for hydrophilization, preferable activating light is weak ultraviolet light emitted from ultraviolet light irradiating lamp (an UV lamp) 8, as shown in step (e) in FIG. 3. Ultraviolet light irradiating lamp 8 is utilized because weak activating light is sufficient to delete an image area differently from forming an image and an ultraviolet irradiating lamp 8 is ordinary available on the market at a low cost.

Next, the organic compound is applied to the hydrophilic surface of the photosensitive layer 3 and the surface of the photosensitive layer 3 is covered with the hydrophobic coating 4 made of the organic compound by an interaction between the photosensitive layer 3 and the organic compound so that the surface of the photosensitive layer 3 is converted to hydrophobic. The interaction between the photosensitive layer 3 and the organic compound preferably accompanies a chemical reaction and preferably bounds the organic compound to the surface of the photosensitive layer 3 with sufficiently strong adhesion because the surface covered with the organic compound is functioning as an image area 6 during printing; if the organic compound detaches from the photosensitive layer 3 during printing, the image area 6 vanishes whereupon resultant printing matter problematically has a thinner line or a paled color portion. The step (a) shows a state in which the entire surface of the printing plate has been hydrophobized by the organic compound. Here as shown in FIG. 1, plate surface in a hydrophilic state has a contact angle equal to or larger than 50°, preferably equal to or larger than 80°, which is in such a state that hydrophobic printing ink is held with ease but a fountain solution is hardly deposited.

Various manners of applying the organic compound are exemplified by spraying vapor of the organic compound onto the surface of the photosensitive layer 3; dip coating the liquid-form organic compound or a liquid including the organic compound using a roller or the like; and coating microdrops of the organic compound formed by a spray. It is possible to select and perform a manner suitable for properties of the organic compound.

The photosensitive layer 3 on which the hydrophobic coating 4 is formed is in a state called “the initial state in making the printing plate ready for printing.” The “initial state” in making the printing plate ready for printing can be regarded as the start of an actual printing process. Specifically, the initial state means a state in which an arbitrary image, the digital data of which has been already prepared, is about to be formed onto the printing plate.

In succession, a non-image area 5 is written into the photosensitive layer 3 on which the hydrophobic coating 4 is formed to carry out an image forming step. Writing of the non-image area 5 is performed conforming to digital data of an image so as to coincide with the digital data. This non-image area 5 is in a hydrophilic state with a contact angle of water thereon equal to or smaller than 10°, in which the fountain solution is held with ease but the printing ink is hardly deposited.

For an appearance of a hydrophilic non-image area 5 in line with image data, the activating light is irradiated a portion of the surface of the photosensitive layer 3 and action of the photocatalyst hydrophilizes the irradiated portion. The action of the photocatalyst mainly oxidatively decomposes the hydrophobic coating 4 converting the surface of photosensitive layer 3. If the photocatalyst exhibits hydrophobicity at the initial state, the action also converts a property of the photocatalyst to hydrophilicity. On the other hand, since a plate surface portion that has not been irradiated with the activated light remains in a hydrophobic state, a latent image that is a combination of the hydrophobic image area 6 and the hydrophilic non-image area 5 is formed on the surface of the printing plate whereupon the printing plate is made ready for printing. In the illustrated example, a non-image area 5 is written with an imaging head 7 utilizing visible light exemplified violet leaser beams having a wavelength of 405 nm so that the non-image area 5 is formed on the hydrophobic surface of the photosensitive layer 3 as shown in the step (b). This completes to form the image area 6 and the non-image area 5 on the surface of the printing plate and to make the printing plate ready for printing.

Here, visible light is used because of advantages of easy handling and compact size of the device. Alternatively, it is possible to use ultraviolet light as the activating light as well as visible light. Any system utilizes light having a wavelength equal to or shorter than that of visible light, which system is exemplified by an imaging head equipped with a light source and a micro-mirror and the product name of which is the UV-setter™ 710 manufactured by basysPrint GmbH (Germany), can be used as an imaging head for forming an image on the surface of the printing plate.

Upon completion of the above steps, a so-called emulsion ink of a mixture of a hydrophobic printing ink and the fountain solution is applied to the printing plate surface and thereby making a printing plate ready for printing as shown in FIG. 4 is completed. In FIG. 4, the hatching portion represents a state in which the hydrophobic ink is attached to the hydrophobic image area 6. The remaining white background portion, i.e., the hydrophilic non-image area 5, represents a state in which the fountain solution preferentially adheres while the hydrophobic ink is repelled and not deposited. The emergence of an image allows the photosensitive layer 3 to function as a printing plate that is ready for printing. After that, a normal printing process takes place and is accomplished.

Next, a method for regenerating the printing plate will now be described. “Regenerating of the printing plate” represents a conversion of a property of the photocatalyst from hydrophilic to hydrophobic to restore the printing plate to the initial state in making a printing plate by hydrophilizing the entire surface of the printing plate, at least part of which is exhibiting hydrophobic while the remaining part of which is exhibiting hydrophilic, and successively applying the organic compound to the hydrophilic surface of the printing plate in order to interact the organic compound with the surface of the photosensitive layer 3 so that the hydrophilic surface of the photosensitive layer 3 is covered with the hydrophobic coating 4 made of the organic compound.

At the beginning, ink, fountain solution, paper dust and the like remaining on the surface of the printing plate after printing are removed at an ink removing step (step (d)). The ink removal is performed by one of moving ink to paper while a print press is operating without supplying the printing plate with ink; wiping off ink with a reeled cleaning cloth tape; wiping off the ink with a roller around which cloth is wrapped; and by spraying a solvent having an effect on washing off ink onto the surface of the printing plate wash off ink.

After that, as shown in the step (e), the entire surface of the photosensitive layer 3, at least part of which is in a hydrophobic state because of the remaining hydrophobic coating 4, is irradiated with the activating light. That hydrophilizes an image area 6 formed by the hydrophobic coating 4 so that the entire surface of the photosensitive layer 3 comes into a hydrophilic state, which has the contact angle of water thereon up to 10°, that is, into a state shown in FIG. 2. The activating light used for hydrophilization can be weak ultraviolet light emitted from, for example, the ultraviolet irradiating lamp (activating light irradiating lamp) 8, as described above.

The organic compound is then applied to the surface of the photosensitive layer 3, the entire surface of which has been restored to a hydrophilic state, so that the organic compound interacts with the surface of the photosensitive layer 3. Thereby, the surface of photosensitive layer 3 is covered with the hydrophobic coating 4 made of the organic compound, as shown at the step (a), and the photosensitive layer 3 is restored to the initial state in making the printing plate ready for printing. The step (e) is performed in order to completely delete an image area formed on the printing plate surface. However the hydrophilizing step should by no means performed each time of regeneration. If the step is not performed, it is practically possible to regenerate the printing plate. The step (e) can be therefore omitted and the step (d) can be followed immediately by the step (a).

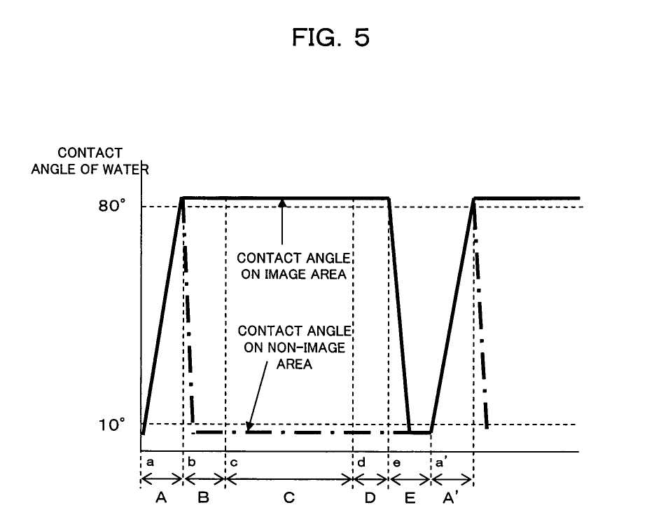

The above description is summarized in graph FIG. 5. Plots in abscissa represent time (or the procedural steps); and plots in ordinate represent the contact angle of water on the surface of printing plate. The graph indicates the change in the contact angle (i.e., a hydrophobic/hydrophilic state) of water on the surface of the photosensitive layer 3 of this embodiment in accordance with the passage of time and performance of steps. The one-dotted line in the graph represents the contact angle of water on the non-image area 5 of the photosenstive layer 3; and the solid line, that on the image area 6.

First of all, the surface of the printing plate is irradiated with the activating light (time point a) to oxidatively decomposes the hydrophobic coating 4 and the surface of the photosensitive layer 3 becomes a high hydrophilic state in which the contact angle of water thereon is up to 10°.

In the first hydrophobizing step (step A), the organic compound is applied to the surface of the photosensitive layer 3 so as to react with or vigorously interact with the surface of the photosensitive layer 3. As a result, the hydrophobic coating 4 is formed on the surface of the photosensitive layer 3 and the surface of the photosensitive layer 3 is converted from hydrophilic to hydrophobic. Upon completion of the hydrophobizing step, the printing plate has come into the initial state in making the printing plate ready for printing and the surface of the photosensitive layer 3 at that time has a contact angle of water thereon of 50° or larger, preferably 80° or larger.

In succession, a non-image area writing step (step B) starts writing a non-image area 5 on a portion of the hydrophobic surface of the photosensitive layer 3 covered with the hydrophobic coating 4 with activating light (time point b). As a consequence, the portion on the hydrophobic coating 4, which portion has been irradiated with the activating light, is removed by oxidative decomposition caused by an action of the photocatalyst, and the photosensitive layer 3 at the irradiated portion is converted from hydrophobic to hydrophilic, that is, a contact angle of water on the irradiated portion becomes up to 10°. On the other hand, the remaining portion of the surface of the photosensitve layer 3, which portion has not been irradiated with the activating light, remains hydrophobic because of the hydrophobic coating 4 so that the portion not irradiated with the activating light serves as a hydrophobic image area 6 and the portion irradiated with the activating light serves as a hydrophilic image area 5. Whereupon the surface of the printing can function as a printing plate ready for printing. After completion of writing of the non-image area 5, printing process takes place (time point c) to perform the printing step (step C).

After completion of printing (time point d), ink, dust and the like are removed in ink removing step (step D). After the ink removal, the hydrophilizing step (step E) for the image area 6 starts irradiation of the entire surface of the printing plate with the activating light (time point e). Thereby, the action of the photocatalyst oxidatively decomposes the organic compound and removes the hydrophobic coating 4 whereupon the entire surface of the photosensitive layer 3 becomes hydrophilic again (time point a′).

Then, in the next hydrophobizing step (step A′), the surface of the photosensitive layer 3 is restored to the initial state in making the printing plate ready for printing by applying the organic compound to the surface of the photosensitive layer 3 so that the organic compound reacts with or strongly interacts with the surface of the photosensitive layer 3 and the surface of the photosensitive layer 3 is covered with the organic compound. As a result, the printing plate is reused.

As mentioned above, the printing plate according to the first embodiment is advantageously reusable and additionally regeneratable in a short-term cycle. The usage of the organic compound, a monomolecular layer of which can hydrophobize a plate, requires only a short time for processes to make the printing plate ready for printing and regenerate the printing plate, e.g., reduced time to form an image and facilitation of cleaning of a printing plate used for printing. It is therefore possible to complete the entire printing process in an extreme short time.

Realization of regeneration and reusing of a printing plate can greatly reduce the amount of printing plate waste discarded after printing. Since formation of an image area does not require hydrophobic material such as polymer, the washing solvent is not necessary to wash off the polymer when the printing plate is being regenerated. The printing plate of the first embodiment is ecological friendly, concurrently greatly reducing plate costs.

Since it is further possible to form an image onto the printing plate directly from digital data concerning the image, digitalization of a printing process is realized, thereby greatly reducing corresponding time and costs.

The printing plate according to this embodiment utilizes a photosensitive layer 3 including a photocatalyst responsive to visible light and a visible-light irradiator serves as an imaging head whereupon it is advantageously possible to make a printing plate ready for printing and regenerating the printing plate by an apparatus that is more tractable for handling and smaller in size as compared with a system utilizing ultraviolet activating light.

Hereinafter, a description is made in relation to making and regenerating a printing plate with reference to the results of experiment and observation by the Inventors.

1. Preparation of Catalyst:

The Ammonia solution was added to a starting material of a titanium sulfate (a product of Wako Pure Chemical Industries, Ltd.) while stirring the mixture to obtain a titanium sulfate hydrolysate, which was filtered through a Buchner funnel. The residue titanium sulfate hydrolysate was washed with deionized water until electrical conductivity of the filtrate came to be 2 μS/cm or lower. After washing, the hydrolysate was dried at room temperature and then burned in the atmosphere for two hours at 400° C. The burned product was roughly milled with a mortar, and a powder-form photocatalyst was obtained.

2. Confirmation of Visible-Light Activity:

The above powder-form photocatalyst (0.2 g) was evenly spread over the bottom of a sealable cylindrical reaction container (500 ml) made of Pyrex® glass. The atmosphere in the reaction container was deaerated and substituted with highly-purified air. Acetone (500 ppm) was added into the reaction container and was absorbed into the photocatalyst in a dark place for 10 hours at 25° C. until the contents in the reaction container reached absorption equilibrium. After that, the contents were irradiated with light (having the major wavelength of 470 nm) emitted from blue LED (produced by Nichia Corporation). As a result of a follow-up measurement on amounts of acetone and carbon dioxide (CO₂) using a gas chromatograph manufactured by Shimazu Corporation, the Inventors confirmed that irradiation with light emitted from the blue LED for 25 hours decomposed all acetone in the reacting container and generated carbon dioxide CO₂ the amount of which corresponds to the stoichiometry proportion of the acetone. Namely, the Inventors have confirmed that the photocatalyst exhibited catalytic activity by light having a wavelength of 470 nm.

3. Making of Printing Plate:

The above powder-form photocatalyst was dispersed in deionized water to obtain slurry (solid content 20 wt %), which was milled in a wet mill (product name: dyno mill PILOT) and was used as a photocatalytic dispersed solution. Alkaline degreasing was performed on a stainless-steel (SUS301) substrate 1 the area of which was 280×204 mm and the thickness of which was 0.1 mm to prepare substrate for a printing plate.

Substrate 1 was dip-coated with the mixture of the photocatalytic dispersed solution and TKC-301, product of Tayca Corporation, at a weight ratio of 1:8, and was then heated at 350° C. to form the photocatalyst layer (photosensitive layer) 3 on the surface of substrate 1, which was to serve as a printing plate. The photosensitive layer 3 had a thickness of approximately 0.1 μm. As a result of measurement with contact angle meter, Model CA-W, manufactured by KYOWA INTERFACE SCIENCE CO., LTD., the surface of printing plate obtained a contact angle of 8° in relation to water thereon, which angle is enough to exhibit hydrophilicity.

### EXAMPLE 1

4-1. Hyrophobization of Plate Surface:

Next, titanium-i-propoxyoctylene glycol (2 g, product of Nippon Soda Co., Ltd.) was dissolved in a paraffin solution (98 g, product name Isopar®-L manufactured by Exxon Mobile Corporation), and the resultant solution was used as hydrophobizing solution A. The above printing plate showing hydrophilicity was installed on a desk-top offset printing press (New Ace Pro, trademark; manufactured by ALPHA ENGINEERING INC.), and the hydrophobizing solution A was sprayed over the surface of printing plate, which was dried by a hot-air dryer. After that, printing plate was temporarily displaced from the printing press to measure a contact angle against water using the contact angle meter. The measured contact angle was 75°, which exhibits adequate hydrophobicity so that printing plate 5 was confirmed to be in the initial state in the making of the printing plate.

5-1. Image Formation:

Subsequently, halftone dot images of halftone-dot-area percentages ranging from 10% to 100% were formed onto the surface of the printing plate at 10% intervals by an imaging system utilizing semiconductor laser beams having a wavelength of 405 nm, an output of 5 mW per channel and a beam diameter of 15 μm. The measurement of contact angles using the contact angle meter confirmed that contact angles on portions written and not written by the semiconductor laser beams were respectively 8° and 75° so that the written and not-written portions were respectively a hydrophilic non-image area 5 and a hydrophobic image area 6.

6-1. Printing:

The printing plate was mounted on the New Ace Pro desk-top offset printing press, and the formed image was printed on sheets of paper (ibest paper) using an ink HYECOO B Crimson MZ (trade name; product of Toyo Ink Mfg. Co., Ltd.) and the fountain solution, a 1% solution of LITHOFELLOW (trade mark; product of Mitsubishi Heavy Industries, Ltd.) at a printing speed of 3,500 sheets/hour. The halftone dot images were successfully printed on the first paper sheet.

7-1. Regeneration:

Next, an example of regeneration of the printing plate will be now described. After completion of printing, the entire surface, from which ink, fountain solution, paper dust and the like had been removed, was irradiated with ultraviolet light having a wavelength 254 nm and an illuminance of 10 mW/cm² emitted from a low-pressure Mercury lamp for 20 seconds. Immediately after that, the contact angle of water on a portion on which the half-tone dot image had been formed was measured with the result that the contact angle of water was 8°, which would provide sufficient hydrophilicity. The hydrophobizing solution A was sprayed over the surface of the printing plate and was dried by a hot-air dryer. The contact angle of water was measured with the above contact angle meter and the measured contact angle was 73°, which was exhibiting enough hydrophobicity. The printing plate was confirmed to be restored to the initial state in making the printing plate ready for printing and to be regenerated.

### EXAMPLE 2

4-2. Hyrophobization of Plate Surface:

Isocyanic dodecyl (4 g, a product of Wako Pure Chemical Industries, Ltd.) was dissolved in a paraffinsolution (96 g, product name Isopar®-L manufactured by Exxon Mobile Corporation), and the resultant solution was used as hydrophobizing solution B. The above printing plate exhibiting hydrophilicity was installed on a desk-top offset printing press (New Ace Pro, trademark; manufactured by ALPHA ENGINEERING INC.), and the hydrophobizing solution B was vaporized by a nebulizer, and then applied to the surface of the plate surface, which was dried by a hot-air dryer. Subsequently, the printing plate was temporarily displaced from the printing press and the contact angle against water thereon is measured. The measured contact angle was 78°, which exhibits adequate hydrophobicity.

5-2. Image Formation:

Subsequently, halftone dot images of halftone-dot-area percentages ranging from 10% to 100% were then formed onto the surface of printing plate at 10% intervals by an imaging system utilizing the UV-setter™ 710 manufactured by basysPrint GmbH. The measurement of contact angles using the contact angle meter confirmed that contact angles on portions written and not written by the UV-setter™ were respectively 7° and 78° so that the written and not-written portions were respectively a hydrophilic non-image area and a hydrophobic image area.

6-2. Printing:

Printing was performed in the same manner performed in Example 1. The halftone dot images were successfully printed on the first paper sheet.

7-2. Regeneration:

After completion of printing, the plate surface, from which ink and the other remaining matte had been removed in the same manner as Example 1, was hydrophilized by irradiation with ultraviolet light. The contact angle of water on the hydrophobized plate surface was measured and the measured contact angle was 7°. Subsequently, the hydrophobizing solution B was vaporized by a nebulizer and sprayed over the surface of the printing plate, which was dried by a hot-air dryer. The contact angle of water on the plate surface was measured with the above contact angle meter and the measured contact angle was 77°, which was exhibiting enough hydrophilicity. The printing plate was confirmed to be restored to the initial state in making the printing plate ready for printing.

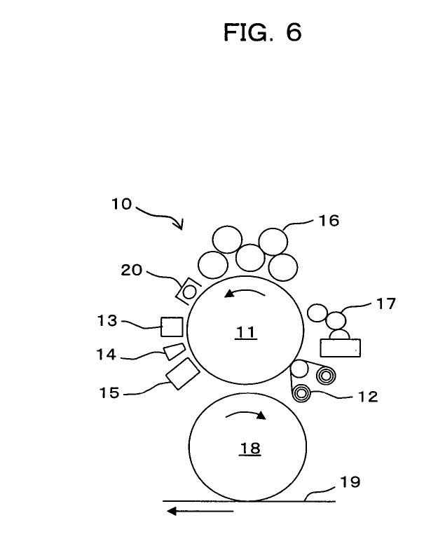

In order to perform printing and regenerating of a printing plate keeping mounted on a printing press, usage of the printing press 10 as shown in FIG. 6 is preferable. In the printing press 10, a plate cleaning unit 12, an image forming unit 13, a hydrophobizing unit 14, a dryer unit 15, inking rollers 16, a fountain solution feeder 17 and a blanket cylinder 18 are installed around the plate cylinder 11. If necessary, the printing press may further include a regenerating activating light irradiating unit 20. The printing plate is wrapped around the curved surface of the plate cylinder 11.

In the printing press 10, the printing plate that has completed printing in the above manner is regenerated by the following procedural steps. At the beginning, the plate cleaning unit 12 is come into contact with the plate cylinder 11 so that ink, fountain solution, paper dust and so forth remaining on the plate surface, i.e., the surface of the printing plate, are wiped off. The plate cleaning unit 12 appearing in FIG. 6 has a mechanism for reeling ink cleaning cloth tape, but can take an alternative form, of course. After that, the plate cleaning unit 12 is disengaged from the plate cylinder 11 and the regenerating activating light irradiating unit 20 irradiates the entire surface of the printing plate with the activating light to hydrophilize the plate surface. The hydrophilization by irradiation with the activating light can be performed if necessary in order to delete an image area formed on the plate surface.

Then the hydrophobizing unit 14 evenly hydrophobizes the surface of the printing plate. Specifically, the organic compound is applied to the surface of the printing plate to react with or vigorously interact with the surface of the photosensitive layer so that the surface of the photosensitive layer is converted from hydrophilic to hydrophobic. In FIG. 6, the hydrophobizing unit takes the form of a nozzle for vaporizing the organic compound and applying the vaporized organic compound to the surface of the printing plate. However hydrophobizing unit should by no means be limited to this. The organic compound applied to the surface of the printing plate is dried by the dryer unit 15 to be fixed. The dryer unit 15 has a mechanism for drying the plate surface by blowing hot or cold air or a mechanism for heating and drying the plate surface by radiant heat. However, the dryer unit 15 is not an essential element to the printing press 10.

In succession, a non-image area is written onto the printing plate with the imaging unit 13 based on digital image data previously prepared. A satisfactory light source of the imaging unit 13 irradiates the activating light, i.e., light having a wavelength equal to or shorter than that of visible light, and is preferably exemplified by a semiconductor laser irradiating a beam having a wavelength of 400-500 nm, or a lamp emitting light in the range of visible to ultraviolet light. When the above steps are completed, the inking rollers 16, the fountain solution feeder 17 and the blanket cylinder 18 are come to contact with the plate cylinder 11. In this arrangement, paper 19 moves in the direction that the arrow of FIG. 6 directs, contacting with the blanket cylinder 18, so that fountain solution and ink is sequentially applied to the surface of the printing plate and printing is carried out.

It is possible for the printing press 10 to undergo the series of steps from regenerating of the printing plate to making the printing plate ready for printing—cleaning the printing plate after printing; deleting an image area by irradiation with the activating light; hydrophobizing the plate surface; and writing a non-image area—while the printing plate is mounted on the printing press 10. This enables the printing press 10 to perform continuous printing process without halting the operations and also without being interrupted by replacement of a printing plate.

As the structure of the printing press 10, the printing plate is wrapped around the plate cylinder 11, but the structure should by no means be limited to this. Alternatively, a photosensitive layer including a photocatalyst responsive to visible light as well as ultraviolet light may be formed directly on the plate cylinder 11, that is, the plate cylinder 11 and the printing plate is formed into one unit.

What is claimed is:

1. A reusable printing plate on which an image is formed by irradiating a surface of the printing plate with light and which is regenerated by deleting the formed image, wherein a coating (4) made of an organic compound having a hydrophobic group is formed on the surface of a photosensitive layer (3) including a photocatalyst that responds to visible light.

2. A printing plate according to claim 1, wherein the photocatalyst responds to light having a wavelength equal to or shorter than 600 nm.

3. A printing plate according to claim 1 or 2, wherein the image is formed by exposure the hydrophilic surface of said photosensitive layer (3) which exposure is caused by decomposing said organic compound (4) by the photocatalyst.

4. A printing plate according to claim 3, wherein the printing plate is regenerated by covering the hydrophilic surface of said photosensitive layer (3) with the organic compound (4) which covering is caused by an interaction performed between said organic compound (4) and said photosensitive layer (3).

5. A printing plate according to claim 4, wherein the interaction between said organic compound (4) and said photosensitive layer (3) accompanies a chemical reaction.

6. A printing plate according to one of claims 1-5, wherein the photocatalyst is a modified titanium oxide photocatalyst.

7. A method regenerating and reusing a printing plate defined in claim 4, comprising the steps of:
upon completion of printing,
removing ink from the surface of the printing plate;
hydrophobizing the entire surface of the printing plate by covering an exposed portion of the photosensitive layer (3) with the organic compound (4); and
forming the image by irradiating a portion of the printing plate with visible light so that the organic compound (4) at the irradiated portion is decomposed by an action of the photocatalyst and the hydrpophilic surface of the photosensitive layer at the irradiated portion is exposed.

8. A method for regenerating and reusing a printing plate according to claim 7, wherein said step of hydrophobizing is performed by applying vapor of the organic compound (4) to the surface of the printing plate to interact the organic compound (4) with the photosensitive layer (3) so that the hydrophilic surface of the photosensitive layer (3) is covered with the organic compound (4).

9. A method for regenerating and reusing a printing plate according to claim 7, wherein said step of hydrophobizing is performed by applying a liquid of the organic compound (4) or a liquid including the organic compound (4) to the surface of the printing plate to interact the organic compound (4) with the photosensitive layer (3) so that the hydrophilic surface of the photosensitive layer (3) is covered with the organic compound (4).

10. A method for regenerating and reusing a printing plate according to one of claims 7-9, wherein
before covering the exposed portion of the photosensitive layer (3) with the organic compound (4) in said step of hydorphobizing,
irradiating the entire surface of the printing plate with light having a wavelength equal to or shorter than that of visible light.

11. A method for regenerating and reusing a printing plate according to one of claims 7-10, wherein said step of ink removing is performed by moving the ink to paper while a printing press is operating without supplying the printing plate with ink.

12. A method for regenerating and reusing a printing plate according to one of claims 7-10, wherein said step of ink removing is performed by wiping off the ink with a reeled cleaning cloth tape.

13. A method for regenerating and reusing a printing plate according to one of claims 7-10, wherein said step of ink removing is performed by wiping off the ink with a roller around which cloth is wrapped.

14. A method for regenerating and reusing a printing plate according to one of claims 7-10, wherein said step of ink removing is performed by spraying a solvent having an effect on washing off ink onto the surface of the printing plate to wash off the ink.

15. A printing press comprising:
a plate cylinder (11) having a curved surface for supporting a printing plate defined in claim 4;
an image forming unit (13) for writing a non-image area by irradiating a portion of the surface of the printing plate with visible light so that the organic compound (4) at the irradiated portion is decomposed by an action of the photocatalyst and the hydrophilic surface of the photosensitive layer (3) at the irradiated portion is exposed; and
a hydrophobization unit (14) for hydrophobizing the entire surface of the printing plate by covering the exposed portion of the photosensitive layer (3) with the organic compound (4).

16. A printing press according to claim 15, further comprising a plate cleaning unit (12) for removing ink from the surface of the printing plate.

17. A printing press according to claim 15 or 16, further comprising an image area deleting unit (20) for deleting an image area by irradiating the entire surface of the printing plate with light having a wavelength equal to or shorter than that of visible light.
